(19) United States
(12) Patent Application Publication
(10) Pub. No.: US 2002/0161823 A1
(43) Pub. Date: Oct. 31, 2002

(54) Dynamically defining workflow processes using generic nodes

(76) Inventors: Fabio Casati, Palo Alto, CA (US); Ming-Chien Shan, Saratoga, CA (US)

Correspondence Address: HEWLETT-PACKARD COMPANY, Intellectual Property Administration, P.O. Box 272400, Fort Collins, CO, 80528-9599, US

(21) Appl. No.: 09/842,496

(22) Filed: Apr. 25, 2001

(51) Int. Cl. G06F 15/16

(52) U.S. Cl. 709/202; 709/205

(57) ABSTRACT

A computer-enabled workflow process system includes a node group database that stores a group of work nodes referred to by a generic node. A work node defines a workflow action and data items to be read and written when executing the workflow action. The workflow process system also includes a workflow engine that executes a workflow process having the generic node. The workflow engine accesses the node group database for the group of work nodes when the generic node is to be executed so as to allow dynamic composition and modification of the workflow process. Work nodes can be added to or removed from the node group without requiring that the workflow process be redefined. A computer-enabled method of compiling and executing a workflow process having at least a generic node is also described.

### BACKGROUND OF THE INVENTION

1. Field of the Invention

The present invention pertains to workflow technology. More particularly, this invention relates to dynamically defining and executing workflow processes using generic nodes such that changes in the environment can be made without redefining the workflow processes.

2. Description of the Related Art

Workflow management is a rapidly evolving technology that many businesses in a variety of industries utilize to handle business processes. A business process is simply a set of one or more linked activities that collectively realize a business objective or a policy goal, typically within the context of an organizational structure defining functional roles and relationships. A workflow is defined as the automation of a business process, in whole or in part, during which documents, information, or activities are passed from one participant to another, according to a set of predefined rules. A workflow process management (WFPM) system defines, creates, and manages the execution of workflow processes. It provides the enabling technologies for actually performing workflow processes.

FIG. 1 shows a workflow process 10 that is created using prior art and to be executed on a prior art WFPM system. As can be seen from FIG. 1, the workflow process 10 is described as a directed graph including a set of nodes connected by arcs. There are two kinds of nodes: work nodes (e.g., nodes 11-12 and 14-16) and rule/decision nodes (e.g., nodes 13 and 17). The work nodes are shown as square and the rule nodes are shown as circle. A work node is a placeholder for a process activity, which is a logical representation of a piece of work contributing towards the accomplishment of the workflow process 10. A process activity represents work to be done by a human user or by a software application, and it may include timeout and deadline information and input and output data. A rule node is used to specify workflow processes that are more complex than a simple sequence. A rule language is used to program the rule node decision. When executed, a rule node determines which outward arcs to fire based on the status passed along the inward arcs, the time at which each inward arc is fired and process-relevant data associated with the process instance.

Rule nodes are also used to support events. A rule node can raise events when certain conditions are met as defined by the rules and an event can activate rule nodes that have subscribed to receive the event.

In recent years, the Internet and World Wide Web (WWW) has become the platform through which many companies communicate with their partners, interact with their back-end systems, and perform electronic commerce transactions. Today, organizations use the Web not only as an efficient and cost-effective way to sell products and deliver information, but also as a platform for providing services to businesses and individual customers. This type of services is typically referred to as e-services. Examples of e-services include bill payment, customized on-line newspapers, or stock trading services.

E-services are typically provided by combining the Web and WFPM technologies together. The e-service environment also creates the business opportunity for providing value-added, integrated services, which are delivered by composing existing e-services, possibly offered by different companies. Composite services are similar to workflows, since they need to specify the constituent services and their execution dependencies. Hence, composite services can be influenced through workflow technology.

However, unlike “traditional” workflow processes, which are mostly executed in a predictable and repetitive way, composite service processes delivered through the Internet have to cope with a highly dynamic environment, where new services become available on a daily basis and the number of service providers is constantly growing. This typically requires existing workflow processes to be redefined in order to include the new services. For example, FIG. 1 lists three alternatives for the MOVE workflow process 10. If a fourth alternative (e.g., ship shipment) is to be added to the workflow process 10, the process needs to be redefined to add additional branches representing the new services. This makes the workflow process not adaptive to changes.

However, the availability of many service providers from different countries increases the competition and forces companies to provide customized services to better satisfy the need of every individual customer. This means that the process 10 of FIG. 1 may need to be constantly defined and redefined. In other words, workflow processes (e.g. the workflow process 10) must be made to be easily adaptable to the changing environment.

Clearly, it is unfeasible to continuously change the process to reflect changes in the business environment, since these occur too frequently and modifying a process definition is a delicate and time-consuming activity. But in order to stay competitive, service providers must constantly modify the services that they provide in order to offer the best available service in every given moment to every specific customer.

### SUMMARY OF THE INVENTION

One feature of the present invention is to allow workflow or service processes to be able to transparently adapt to changes in the environment and to the needs of different customers with minimal user intervention.

Another feature of the present invention is to allow dynamic workflow process composition and modification.

A further feature of the present invention is to allow dynamical modification of workflow or service processes in a simple and effective way with minimal user intervention.

A computer-enabled workflow process system includes a node group database that stores a group of work nodes referred to by a generic node. A work node defines a workflow action and data items to be read and written when executing the workflow action. The workflow process system also includes a workflow engine that executes a workflow process having the generic node. The workflow engine accesses the node group database for the group of work nodes when the generic node is to be executed so as to allow dynamic composition and modification of the workflow process. Work nodes can be added to or removed from the node group without requiring that the workflow process be redefined.

A computer-implemented method of executing a workflow process having at least a generic node in a workflow process management system is also described. The method includes the step of storing a group of work nodes corresponding to the generic node in a node group database. The node group database stores a plurality of groups of work nodes. A work node defines a workflow action and data items to be read and written when executing the workflow action. Work nodes can be added to or removed from the node group without requiring that the workflow process be redefined. The method also includes the step of accessing the node group database for the group of work nodes corresponding to the generic node when the generic node is to be executed. Then a number of work nodes in the node group are executed such that the workflow process can be dynamically composed and modified without requiring that the workflow process be redefined.

In addition, a computer-implemented method of compiling a workflow process having a plurality of nodes is also described. The method includes the step of determining if a node is a generic node. If the node is a generic node, then the generic node is compiled. If the node is a work node, then the work node is compiled. The method repeats the above mentioned steps until there is no more node in the workflow process that needs to be compiled.

Other features and advantages of the invention will become apparent from the following detailed description, taken in conjunction with the accompanying drawings, illustrating by way of example the principles of the invention.

### BRIEF DESCRIPTION OF THE DRAWINGS

FIG. 1 shows a workflow process defined in accordance with prior art.

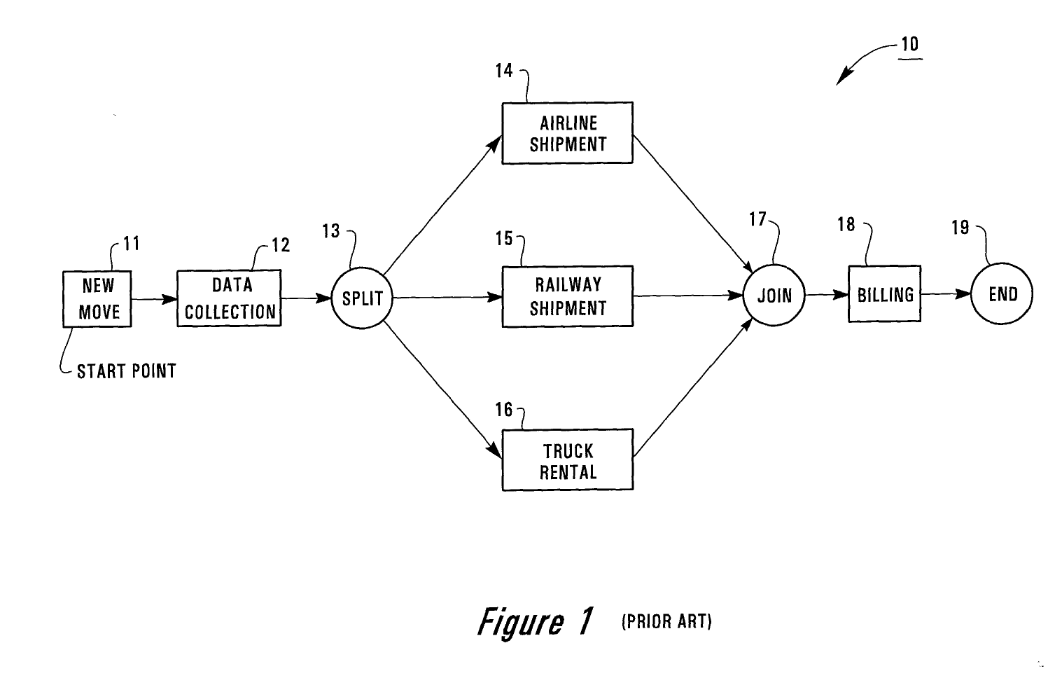

FIG. 2 shows a workflow process defined using a generic node in accordance with one embodiment of the present invention.

FIG. 3 shows the node group referred to by the generic node of the workflow process of FIG. 2.

FIG. 4 shows a workflow process management system in accordance with one embodiment of the present invention, wherein the workflow process management system defines and manages the execution of the workflow process shown in FIG. 2.

FIG. 5 shows the structure of the workflow engine of the workflow process management system of FIG. 4.

FIG. 6 is a flow chart diagram showing the operation of the workflow engine of FIG. 4.

FIG. 7 is a flow chart diagram showing the process of the workflow definition module of the workflow process management system of FIG. 4.

FIG. 8 shows in more detail the generic node compile and check step of FIG. 7.

### DETAILED DESCRIPTION OF THE INVENTION

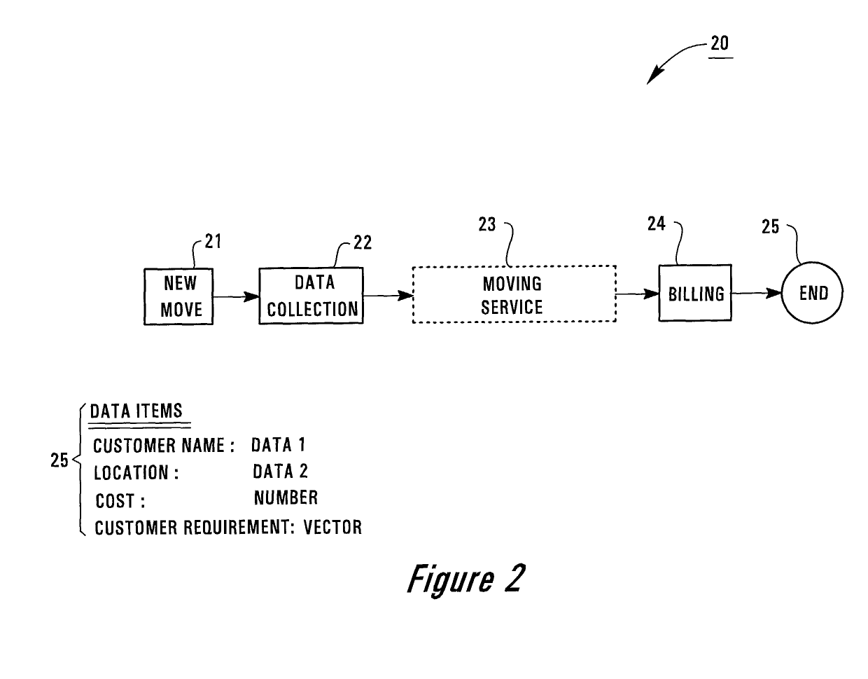

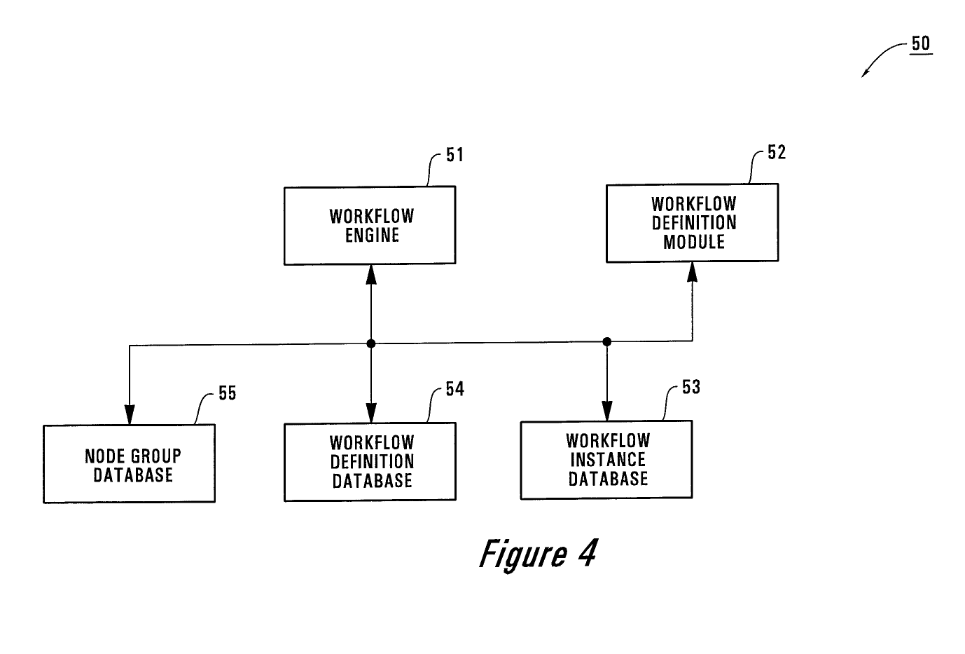

FIG. 2 shows a workflow process 20 that is compiled and executed by a Workflow Process Management (WFPM) system 50 of FIG. 4 in accordance with one embodiment of the present invention. The workflow process 20 defines a move service process, as an example. The WFPM system 50 will be described in more detail below.

The workflow process 20 can be defined using prior art technique. As can be seen from FIG. 2, the workflow process 20 includes work nodes 21, 22, and 24, each defining a workflow action. For example, the work node 22 defines a workflow action of collecting data for the workflow process. In addition, the workflow process 20 includes a generic node 23. The generic node 23 can also be referred to as a generic service node. The workflow process 20 also includes data items 25. Because the workflow process 20 defines a move process, the data items 25 can include a CUSTOMER NAME data item, a LOCATION data item, a COST data item, and a CUSTOMER_REQUIREMENT data item. The CUSTOMER_REQUIREMENT data item is a vector which specifies the customer's requirements (e.g., air shipment, rail shipment, or truck shipment) for the move process. In addition, the data items 25 may include many more data entries.

A work node (such as the work node 21, 22, or 24), however, includes even more attributes or data items. For example, the data items included in a work node may include a list of input data items, a list of output data items, deadlines, cost, resources required, etc. Alternatively, the data items included may be more or fewer than the above mentioned.

On the other hand, the generic node 23, unlike a work node (e.g., the work node 22), does not refer to a single workflow action. This means that if the generic node 23 is defining a moving service (as shown in FIG. 2), the generic node 23 does not define a particular moving service (e.g., air shipment, railway shipment, or truck shipment) that is represented by a workflow action. Instead, the generic node 23 is not statically bound or limited to a service or workflow action.

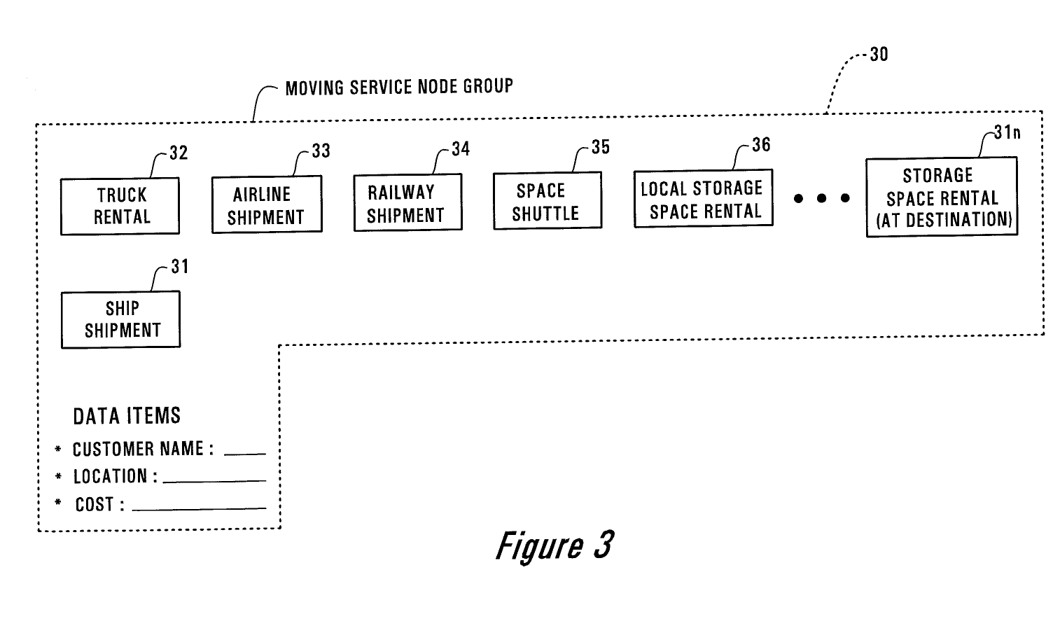

In accordance with one embodiment of the present invention, the generic node 23 is a placeholder that includes configuration parameters (i.e., attributes) to be set with a list of actual nodes from a group of work nodes to be activated. Here, the notion of generic nodes (e.g., the node 23) means that the generic node 23 is an abstract node which refers to a group of work nodes (i.e., the node group 30 in FIG. 3). The generic node 23 is simply an empty node that only specifies attributes of the generic node 23. The attributes identify a group of work nodes that might replace the generic node 23 during the execution of the workflow process 20. Which of the work nodes within the node group that will replace the generic node 23 is governed by the attributes in the generic node 23. The values of the attributes or configuration parameters can be set either at process instantiation time (through the process instance input parameters) or at the runtime (by a previously executed work node). The specified work nodes will be executed in parallel or sequential, depending on an EXECUTION MODE attribute of the generic node 23. The attributes of the generic node 23 will be described in more detail below.

In accordance with one embodiment of the present invention, the attributes specified by a generic node (e.g., the generic node 23) must include a SERVICE SELECTION VARIABLE attribute that specifies the name of one of the data items in the workflow process 20 (e.g., the CUSTOMER_REQUIREMENT data item), a SERVICE NODE GROUP attribute, and an EXECUTION MODE attribute. The SERVICE NODE GROUP attribute specifies the node group that contains the work nodes that will replace the generic node 23. The SERVICE SELECTION VARIABLE attribute specifies which of the work nodes within the specified node group are to be employed to replace the generic node 23 during the execution of the workflow process 20. The EXECUTION MODE attribute specifies the whether the specified work nodes are to be executed in parallel or sequential. The following is a sample XML (Extended Markup Language) description or specification of the generic node 23 of the workflow process 20 of FIG. 2.

<GENERIC_NODE id=“Moving_Service”>

<NAME> Moving Service</NAME>

<SERVICE_NODE_GROUP> Moving Service Node Group

</SERVICE_NODE_GROUP>

<DESCRIPTION> Placeholder for work nodes related to a moving service, to be executed in parallel

</DESCRIPTION>

<SERVICE_SELECTION_VAR> CUSTOMER_REQUIREMENT

<SERVICE_SELECTION_VAR>

<EXECUTION_MODE> mode=“parallel” </EXECUTION_MODE>

</GENERIC NODE>

As can be seen from the above and as an example, the generic node 23 specifies or refers to a moving service node group because its SERVICE NODE GROUP attribute so indicates. FIG. 3 shows one embodiment of the service node group 30, which will be described in more detail below.

As can be seen from FIG. 3, the service node group 30 includes a number of work nodes 31 through 31n, each defining a workflow action. Each workflow action defined by the corresponding work node supports or specifies a relocation service or action. For example, the work node 33 specifies the air shipment service while the work node 34 specifies the railway shipment service. In other words, the node group 30 includes or lists all types of relocation services.

Moreover, the node group 30 can dynamically change its work nodes within the group. For example, when a new moving service (e.g., local storage space rental) is created, the node group 30 can add the work node 36 specifying the newly created service without modifying the workflow process 20 of FIG. 2. The node group 30 can be referred to by the generic node 23 of FIG. 2. The node group 30 can also be referred to by more than one generic nodes.

Once the node group 30 is identified by the SERVICE NODE GROUP attribute of the generic node 20 of FIG. 2, which of the work nodes 31-31n within the node group 30 will be employed to replace the generic node 23 depends on the SERVICE SELECTION VARIABLE attribute of the generic node 23. For example, if the user of the workflow process 20 of FIG. 2 specifies the air shipment, the railway shipment, and the truck shipment, the SERVICE SELECTION VARIABLE attribute of the generic node 23 of FIG. 2 selects the work nodes 32-34. The SERVICE SELECTION VARIABLE attribute of the generic node 23 refers to the CUSTOMER_REQUIREMENT data item of the workflow process 20. As described above, the CUSTOMER_REQUIREMENT data item is a vector which specifies the customer's requirements (e.g., air shipment, rail shipment, or truck shipment) for the move process in terms of names of work nodes.

The concept of defining a workflow process with generic nodes (e.g., the generic node 23) allows work nodes to be dynamic selected for execution (in sequence or parallel). This also allows modification of a workflow process (e.g., the workflow process 20) without redefining the workflow process. As a result, the workflow processes can provide personalized services to better satisfy the needs of every individual user or customer. The generic node approach provides considerable flexibility and supports the needed changes of services in a dynamic way to cope with today's changing environments. In particular, it minimizes the effort of changing the workflow process when new services becomes available or when existing services are modified. This is due to the fact that the generic node (e.g., the generic node 23 of FIG. 2) dynamically adapts to these changes and retrieves the latest work node definitions. In other words, the employment of generic nodes in workflow processes allows dynamic workflow process composition and modification. It also allows workflow or service processes to be able to transparently adapt to changes in the environment and to the needs of different customers with minimal user intervention. In addition, this allows dynamical modification of workflow or service processes in a simple and effective way with minimal user intervention. The execution of a workflow process with generic nodes will be described in more detail below, also in conjunction with FIGS. 4 through 8.

Referring to FIGS. 2 and 4, as described above, the defined workflow process 20 having the generic node 23 (FIG. 2) is compiled and executed by the WFPM system 50 of FIG. 4 in accordance with one embodiment of the present invention. As will be described in more detail below, the WFPM system 50 includes a node group database 55 that stores groups of work nodes (e.g., the node group 30 of FIG. 3), each group being referred to by at least one generic node. A node group can, however, be referred to by one generic node or by two or more generic nodes. The node group database 55 stores all node groups (e.g., the node group 30 of FIG. 3). A node group contains all work nodes that can be selected for execution by the corresponding generic node or nodes bound to this node group.

The WFPM system 50 also includes a workflow engine 51 that executes the workflow process 20 defined with the generic node 23 (both shown in FIG. 2). The workflow engine 51 accesses the node group database 55 for the node group 30 (FIG. 3) when the generic node 23 is to be executed so as to allow dynamic composition and modification of the workflow process 20. This allows work nodes to be added to or removed from the node group 30 (FIG. 3) without requiring that the workflow process 20 be redefined.

As can be seen from FIG. 4, the WFPM system 50 also includes a workflow definition module 52, a workflow instance database 53, and a workflow definition database 54. The workflow definition database 54 stores all workflow processes that have be compiled by the workflow definition module 52. The workflow instance database 53 stores all workflow process instances in execution in the workflow engine 51. In addition, the workflow instance database 53 stores data items of each workflow process instance that is executed by the workflow engine 51. Each of the databases 53-55 can be implemented using known database technology and will not be described in more detail below.

The workflow definition module 52 compiles the workflow process 20 of FIG. 2. The workflow definition module 52 receives workflow process defined by users. In addition, the workflow definition module 52 also receives new nodes or node groups from the users. Moreover, the workflow definition module 52 receives and sends node groups from and to the node group database 55 for storing.

In accordance with one embodiment of the present invention, the workflow definition module 52 compiles a workflow process having generic nodes (e.g., the generic node 23 of FIG. 2) by first determining if a node is a generic node. If the node is a generic node, then the workflow definition module 52 compiles the generic node. If the node is a work node, then the workflow definition module 52 compiles the work node instead of the generic node. If the node is a rule/decision node, the workflow definition module 52 compiles the rule node.

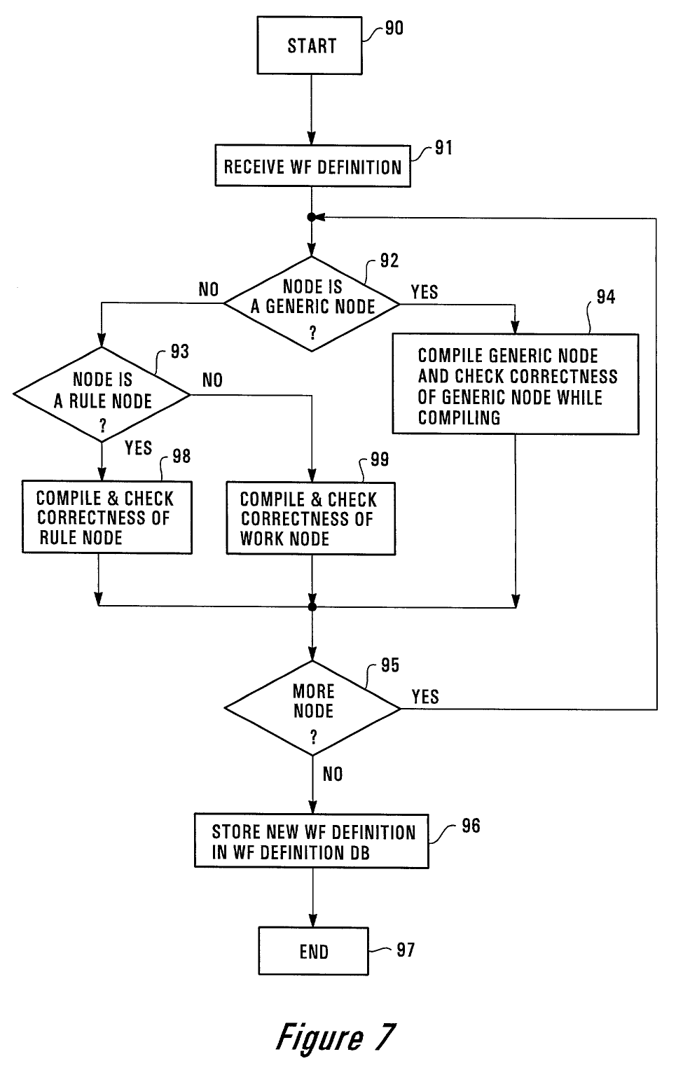

Referring to FIG. 7, the compilation process of the workflow definition module 52 of FIG. 4 starts at the step 90. At the step 91, the workflow definition module 52 (FIG. 4) receives the workflow definition of a workflow process. At the step 92, the workflow definition module 52 determines if the current node is a generic node. If not, the step 93 is the next step. Otherwise, the step 94 is the next step.

At the step 93, the workflow definition module 52 determines if the node is a rule/decision node. If so, the step 98 is performed to compile the rule node. In addition, the correctness of the rule node is checked at the step 98 while the module 52 is compiling the rule node. If the answer is no at the step 93, then the step 99 is performed at which the module 52 compiles the work node. In addition, the workflow definition module 52 checks the correctness of the work node to be compiled.

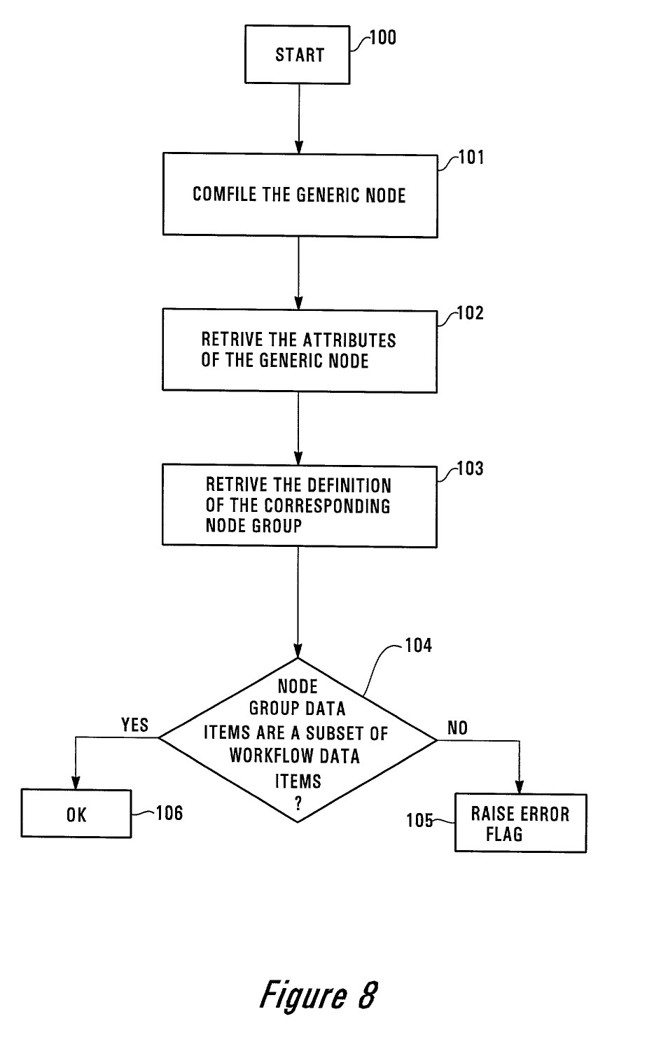

At the step 94, the workflow definition module 52 compiles the generic node and checks the correctness of the generic node while compiling. The compilation and check step 94 includes a number of sub-steps, which will be described in more detail below, also in conjunction with FIG. 8.

Referring back to FIG. 7, at the step 95, the workflow definition module 52 determines if more work node needs to be checked. If so, the process returns to step 92. Otherwise, the step 96 is the next step at which the workflow definition module 52 stores the new workflow definition in the workflow definition database 54 (FIG. 4). The process then ends at the step 97.

Referring to FIG. 8, the compilation and checking of the generic node step 94 of FIG. 7 starts at the step 100. At the step 101, the workflow definition module 52 of FIG. 4 compiles the generic node. At the step 102, the workflow definition module 52 retrieves the attributes of the generic node. At the step 103, the workflow definition module 52 retrieves the definition of the corresponding node group. At the step 104, the workflow definition module 52 determines if the data items in the node group are a subset of the data items of the corresponding workflow process. If not, the step 105 is the next step at which an error flag is raised. Otherwise, the step 106 is performed, at which an OK signal is generated to indicate that the generic node is correctly compiled.

Referring back to FIG. 4, the workflow engine 51 manages execution of the workflow process 20 of FIG. 2. In accordance with one embodiment, when the workflow engine 51 determines that a node in a workflow process instance executed by the workflow engine 51 is a generic node (e.g., the generic node 23), the workflow engine 51 accesses the node group database 55 for the corresponding node group of the generic node (e.g., the node group 30 of FIG. 3). As described above with respect to FIG. 2, the attributes in the generic node also specify which of the work nodes in the node group are to be selected to replace the generic node for execution. The specified work nodes within the node group 30 are then executed such that the workflow process can be dynamically composed and modified without requiring that the workflow process be redefined.

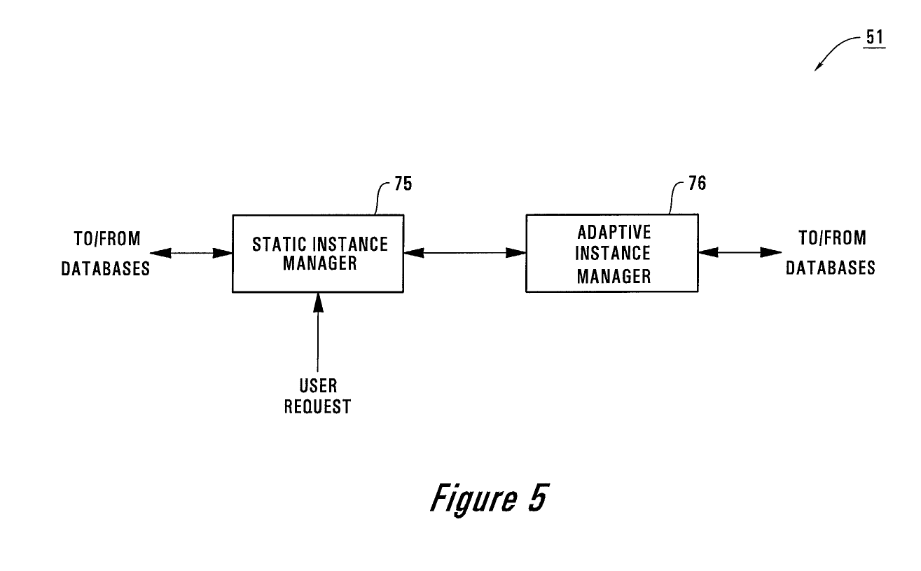

The novel part of the workflow engine 51 is its ability to execute the generic nodes defined in the workflow processes. Thus, the workflow engine 51 includes a static instance manager 75 and an adaptive instance manager 76 (both are shown in FIG. 5). The static instance manager 75 is a prior art instance manager that only manages execution of the work nodes. On the other hand, the adaptive instance manager 76 manages execution of the generic nodes.

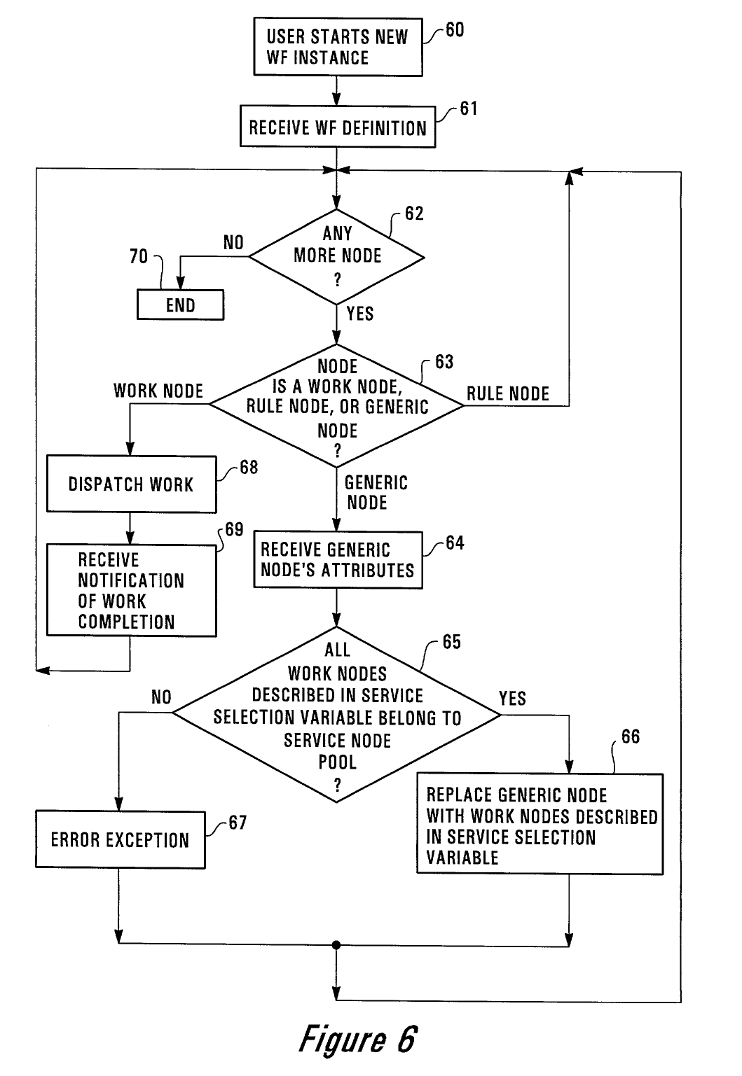

As can be seen from FIG. 5, the static instance manager 75 first receives an external user request to execute a particular workflow process definition (e.g., the workflow process 20 of FIG. 2). The static instance manager 75 then accesses the workflow instance database 53 (FIG. 4) for the requested instance of the workflow process. The static instance manager 75 then executes each work node within the workflow process. When the static instance manager 75 encounters a generic node (e.g., the generic node 23), the adaptive instance manager 76 is invoked to handle the generic node. The adaptive instance manager 76 uses the attributes specified in the generic node to access the node group database 55 (FIG. 4) for the corresponding node group of the generic node. Then the adaptive instance manager 76 replaces the generic node with the specified work nodes (specified in the SERVICE SELECTION VARIABLE attribute of the generic node) from the selected node group. The adaptive instance manager 76 then returns the selected work nodes to the static instance manager 75 for execution. The operation of the workflow engine 51 (including both the static instance manager 75 and the adaptive instance manager 76) is described below, also in conjunction with FIG. 6.

Referring to FIG. 6, the operation starts at the step 60. At the step 61, the workflow engine 51 of FIG. 4 receives the workflow definition of the requested instance of the workflow process from the workflow definition database 54 (FIG. 4). Then the workflow engine 51 determines, at the step 62, whether the definition contains any more node to execute. If not, the execution ends at the step 70.

If, at the step 62, the workflow engine 51 determines more nodes have not been executed, then the step 63 is the next step, at which the workflow engine 51 determines if the node is a work node, a rule/decision node, or a generic node. If the node is a work node then the step 68 is the next step. If the node is a rule node, then the workflow engine 51 returns to the step 62. If the node is a generic node, then the operation of the workflow engine 51 moves to the step 64.

At the step 68, the workflow engine 51 dispatches the work of executing the work node. This is done in prior art manner and will not be described in more detail. At the step 69, the workflow engine 51 receives notification that the dispatched work of the work node is completed. Then the workflow engine 51 returns to the step 62.

At the step 64, the workflow engine 51 receives the attributes of the generic node. Then the workflow engine 51 determines, at the step 65, whether all work nodes described in the data item specified by the SERVICE SELECTION VARIABLE attribute of the generic node belong to the node group specified in the SERVICE NODE GROUP attributed of the generic node. If the answer is yes, then the step 66 is performed at which the generic node is replaced with the work nodes described in the data item specified by the SERVICE SELECTION VARIABLE attribute of the generic node. If the answer is no at the step 65, then the step 67 is performed, at which an error signal is raised to indicate an error. The workflow engine 51 then returns to the step 62 to continue the process until there is no more node in the workflow definition.

In the foregoing specification, the invention has been described with reference to specific embodiments thereof. It will, however, be evident to those skilled in the art that various modifications and changes may be made thereto without departing from the broader spirit and scope of the invention. The specification and drawings are, accordingly, to be regarded in an illustrative rather than a restrictive sense.

What is claimed is:

1. A computer-enabled workflow process system, comprising:
a node group database that stores a group of work nodes referred to by a generic node, wherein a work node defines a workflow action and data items to be read and written when executing the workflow action;
a workflow engine that executes a workflow process having the generic node, wherein the workflow engine accesses the node group database for the group of work nodes when the generic node is to be executed so as to allow dynamic composition and modification of the workflow process.

2. The system of claim 1, wherein work nodes can be added to or removed from the node group dynamically without requiring the workflow process to be redefined.

3. The system of claim 1, wherein the node group database stores a plurality of groups of work nodes, each being referred to by at least one generic node.

4. The system of claim 3, wherein each generic node can refer to more than one group of work nodes.

5. The system of claim 1, wherein the workflow engine further comprises
a static instance manager that manages execution of work nodes within the workflow process;
an adaptive instance manager that accesses the node group database for the group of work nodes to replace the generic node.

6. The system of claim 5, wherein the adaptive instance manager receives attributes of the generic node to determine which work nodes within the group are to replace the generic node.

7. The system of claim 5, wherein the adaptive instance manager further comprises
a first set of instructions that receive attributes of the generic node from the group of work nodes;
a second set of instructions that determine which work nodes within the group are described by the generic node;
a third set of instructions that replace the generic node with all of the work nodes within the group that are described by the generic node.

8. In a workflow process management system, a computer-implemented method of executing a workflow process having at least a generic node, comprising
storing a group of work nodes corresponding to the generic node in a node group database, wherein the node group database stores a plurality of groups of work nodes, wherein a work node defining a workflow action and data items to be read and written when executing the workflow action;
accessing the node group database for the group of work nodes when the generic node is to be executed;
executing work nodes in the group such that the workflow process can be dynamically composed and modified without requiring that the workflow process be redefined.

9. The method of claim 8, wherein work nodes can be added to or removed from the group without redefining its corresponding workflow process.

10. The method of claim 8, further comprising the step of determining when the generic node in the workflow process is to be executed.

11. In a workflow process management system, a computer-implemented method of compiling a workflow process having a plurality of nodes, comprising
(A) determining if a node is a generic node;
(B) compiling the generic node if the node is a generic node;
(C) if the node is a work node, compiling the work node;
(D) repeating the steps (A) through (C) if more nodes in the workflow process need to be compiled.

12. The method of claim 11, wherein the step (B) further comprises the step of checking correctness of the generic node while compiling to avoid run-time errors.

13. The method of claim 12, wherein the step (B) further comprises the steps of
retrieving attributes of the generic node;
retrieving from the node group database a definition of the group;
causing the compilation of the generic node to be proceeded if data items from the group are a subset of data items of the workflow process.

14. The method of claim 11, wherein the step (C) further comprises the step of checking correctness of the work node while compiling.
